(19) United States
(12) Patent Application Publication
(10) Pub. No.: US 2026/0247514 A1
(43) Pub. Date: Aug. 20, 2026

(54) LIGHTING CONTROL SYSTEM FOR VEHICLE

(71) Applicant: Caterpillar Inc., Peoria, IL (US)

(72) Inventors: Samuel Alec Roberts, Stamford (GB); Rodney Glen Stazicker, Peterborough (GB); Amy Caitlin Mitchell, Spalding (GB); Mark Gordon Williamson, Stamford (GB)

(21) Appl. No.: 19/162,527

(22) PCT Filed: Feb. 21, 2024
(86) PCT No.: PCT/US2024/016602

§ 371 Date: Sep. 5, 2025

(30) Foreign Application Priority Data
Mar. 9, 2023 (GB) 2303463.0

(51) Int. Cl. H05B 47/16; B60L 53/16; B60Q 1/00; B60Q 1/24; B60Q 1/32; H05B 47/105

(52) U.S. Cl. CPC H05B 47/16; B60Q 1/0023; B60Q 1/247; B60Q 1/32; H05B 47/105; B60L 53/16; B60Q 2400/40; B60Q 2800/20

(57) ABSTRACT

A lighting control system for a vehicle includes at least one light source and a timer configured to activate the light source for a pre-defined time duration in a triggered state. The lighting control system also includes at least one sensing element configured to generate an input signal indicative of a fluid filling operation of the vehicle and/or an interaction with an electric charging system of the vehicle. The lighting control system includes a controller configured to receive the input signal from the sensing element prior to an elapse of the pre-defined time duration. The controller is also configured to transmit a control signal to the timer based on receipt of the input signal. The control signal is configured to reset the timer to the triggered state to activate the light source until a completion of the fluid filling operation of the vehicle and/or the interaction with the electric charging system of the vehicle.

### TECHNICAL FIELD

The present disclosure relates to a lighting control system for a vehicle and a method of controlling at least one light source associated with the vehicle.

### BACKGROUND

Generally, vehicles, such as, passenger vehicles or work/construction machines incorporate a lighting system to illuminate one or more portions within and/or around the vehicle. In an example, the lighting system may facilitate the operator ingress/egress of operators/passengers from the vehicle. Typically, the lighting system includes one or more lights that are activated to illuminate areas within and/or around the vehicle for a set period of time. The lighting system may further include a timer associated with the lights. The timer may be configured to activate the lights for the set period of time.

A servicing procedure, such as, filling of fluids in a tank of the vehicle and/or connecting an electric charger to the vehicle to charge batteries of the vehicle may require drivers/operators to exit the vehicle and move around the vehicle.

When the driver/operator exits the vehicle, the lights may be in an activated state albeit for a brief period of time. In some cases, while the servicing procedure is being performed, the timer may expire after the set period of time lapses, causing the lights to deactivate. In instances when the servicing procedure is being performed in darkness or at night, deactivation of the lights may cause inconvenience to the drivers/operators in performing the servicing procedure effectively.

U.S. Pat. No. 6,661,338 describes a lighting system for an off-road vehicle includes one or more exit lights that are activated upon operator demand and that are automatically deactivated a designated period of time after exit lights activation, thereby facilitating the operator's departure from the vehicle. The lighting system includes an electrical power source, at least one running light, at least one exit light, and a control system that is coupled to the power source and to the lights and that controls operation of the running light and the exit light. The control system includes a manually operated switch movable between (1) an OFF position in which neither the running light nor the exit light is coupled to the power source, (2) a running light activation position in which at least the running light is coupled to the power source, and (3) an exit light activation position. A timer is operatively coupled to the switch and to the exit light and is operable, in response to selection of the exit light activation position of the switch, to couple the exit light to the power source for a designated period of time. Because exit light activation occurs under operator control rather than automatically, and because exit light activation is not necessarily preceded by running light deactivation or any other operation, the operator is imbued with a sense of control not experienced with other exit light control systems.

### SUMMARY OF THE DISCLOSURE

In an aspect of the present disclosure, a lighting control system for a vehicle is provided. The lighting control system includes at least one light source mounted on the vehicle to illuminate one or more portions of the vehicle. The lighting control system also includes a timer operatively coupled to the light source. In a triggered state of the timer, the timer is configured to activate the light source for a pre-defined time duration. The lighting control system further includes at least one sensing element configured to generate an input signal indicative of a fluid filling operation of the vehicle and/or an interaction with an electric charging system of the vehicle. The lighting control system includes a controller communicably coupled to the sensing element and the timer. The controller is configured to receive the input signal from the sensing element prior to an elapse of the pre-defined time duration. The controller is also configured to transmit a control signal to the timer based on receipt of the input signal. The control signal is configured to reset the timer to the triggered state to activate the light source until a completion of the fluid filling operation of the vehicle and/or the interaction with the electric charging system of the vehicle.

In another aspect of the present disclosure, a method of controlling at least one light source associated with a vehicle is provided. The light source is operably coupled to a timer. In a triggered state of the timer, the timer is configured to activate the light source for a pre-defined time duration. The method includes generating, by at least one sensing element, an input signal indicative of a fluid filling operation of the vehicle and/or an interaction with an electric charging system of the vehicle. The method also includes receiving, by a controller, the input signal from the sensing element prior to an elapse of the pre-defined time duration. The method further includes transmitting, by the controller, a control signal to the timer based on receipt of the input signal. The control signal is configured to reset the timer to the triggered state to activate the light source until a completion of the fluid filling operation of the vehicle and/or the interaction with the electric charging system of the vehicle.

Other features and aspects of this disclosure will be apparent from the following description and the accompanying drawings.

### BRIEF DESCRIPTION OF THE DRAWINGS

FIG. 1 is a schematic side view of a vehicle, according to an embodiment of the present disclosure;

FIG. 2 is a block diagram of a lighting control system for the vehicle of FIG. 1, according to an embodiment of the present disclosure; and

FIG. 3 is a flowchart for a method of controlling one or more light sources associated with the vehicle of FIG. 1, according to an embodiment of the present disclosure.

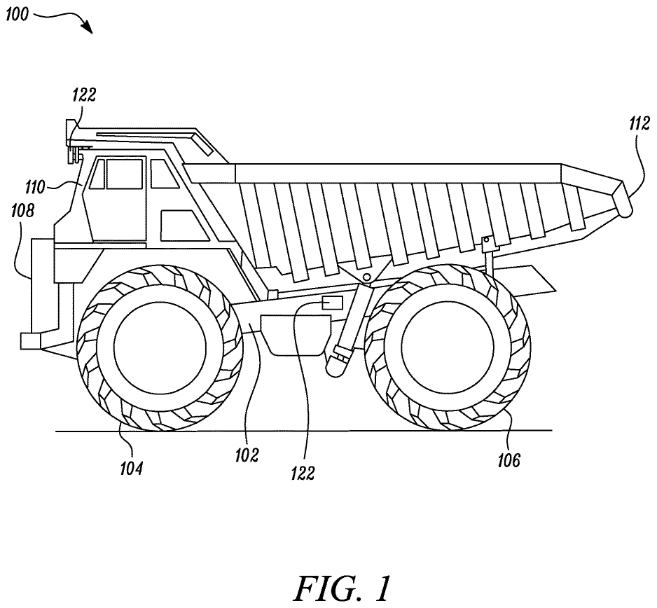

### DETAILED DESCRIPTION

Wherever possible, the same reference numbers will be used throughout the drawings to refer to the same or like parts. Referring to FIG. 1, a schematic side view of a vehicle 100 is illustrated. The vehicle 100 is embodied as a mining truck that may be used to move payload, such as, asphalt, debris, dirt, snow, feed, gravel, logs, raw minerals, recycled material, rock, sand, woodchips, etc. from one location to another location. However, the vehicle 100 may include any other work/construction machine, such as, a hydraulic excavator, a dozer, a wheel loader, a track-type tractor, a motor grader, or any other vehicle that may be used for various purposes, such as, digging, construction, landscaping, and the like. Alternatively, the vehicle 100 may include a passenger vehicle, such as, a car, a van, a bus, etc. that may be used for transportation of passengers from one location to another.

The vehicle 100 includes a frame 102. The frame 102 supports a pair of front wheels 104 and a pair of rear wheels 106 of the vehicle 100. In other examples, the frame 102 of the vehicle 100 may support two or more pairs of front wheels 104 and/or the rear wheels 106. The vehicle 100 further includes a dump body 112 that may hold the payload therein. The vehicle 100 also includes an enclosure 108 and an operator cabin 110 mounted to the frame 102. The enclosure 108 may house a power source, such as, an engine (for e.g., an internal combustion engine), to provide power to various components of the vehicle 100 for operational and mobility requirements.

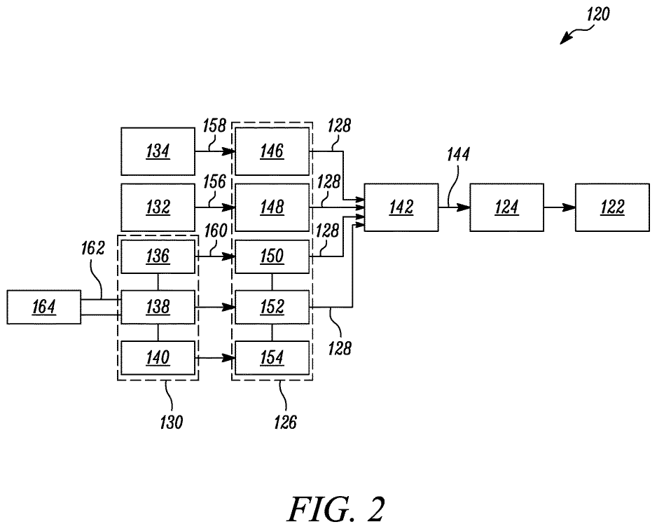

Referring to FIG. 2, additionally, or alternatively, the enclosure 108 (see FIG. 1) may house a portion of an electric charging system 130. For explanatory purposes, various components of the electric charging system 130 are schematically shown in FIG. 2. The electric charging system 130 includes a battery pack 136. The battery pack 136 may include one or more battery modules, each of which may include battery cells, such as, lithium titanate battery cells. Further, the electric charging system 130 includes a charging port 138 in communication with the battery pack 136. The charging port 138 may be removably coupled with a charging cable 162 to charge the battery pack 136. Specifically, the charging cable 162 may connect a charging station 164 with the charging port 138 to eventually charge the battery pack 136. The electric charging system 130 further includes a cover 140 to enclose the charging port 138. The cover 140 may be movable between an open position and a closed position. Specifically, in order to connect the charging cable 162 with the charging port 138, the cover 140 is movable from the closed position to the open position. In the open position, the cover 140 may allow connection of the charging cable 162 with the charging port 138. Further, when the charging cable 162 is disconnected from the charging port 138, the cover 140 is movable from the open position to the closed position. In the closed position, the cover 140 may prevent connection of the charging cable 162 with the charging port 138.

The operator cabin 110 (see FIG. 1) may include one or more controls (not shown) that may enable an operator to control the vehicle 100. The operator may enter and be seated within the operator cabin 110 to perform one or more operations associated with the vehicle 100.

FIG. 2 illustrates a block diagram of a lighting control system 120 for the vehicle 100 of FIG. 1. The lighting control system 120 includes one or more light sources 122 (only two of which are illustrated as examples in FIG. 1) mounted on the vehicle 100 to illuminate one or more portions of the vehicle 100. In some embodiments, the light source 122 may include one or more of a halogen lamp, a fluorescent lamp, a light emitting diode (LED), and the like. In some examples, the light source 122 may be a headlamp, a rear lamp, a flap/cover lamp, a tail gate lamp, a cabin light present within the operator cabin 110, and/or a flood lamp of the vehicle 100. In the illustrated embodiment of FIG. 1, the light source 122 is mounted on the operator cabin 110 of the vehicle 100 and on the frame 102 of the vehicle 100. In some examples, the light source 122 may facilitate an operator's ingress/egress from the vehicle 100. Further, in case of insufficient natural light or an ambient light, such as, in darkness or at night, the light source 122 may allow the operator to move around the vehicle 100.

The lighting control system 120 also includes a timer 124. The timer 124 is operatively coupled to the light source 122. The timer 124 activates/deactivates the light source 122. In a triggered state of the timer 124, the timer 124 activates the light source 122 for a pre-defined time duration. In some examples, the pre-defined time duration may be in a range of 1 minute to 5 minutes, as per application requirements. In a default operation state of the lighting control system 120, the timer 124 may activate the light source 122 based on an opening/closing of a door of the operator cabin 110, an input from a user interface held by the operator, an input from a key of the vehicle 100, and the like. In some examples, the light source 122 may be activated for the pre-defined time duration so as to allow the operator to enter/exit the operator cabin 110. Further, in some cases, the operator may have to perform one or more servicing procedures, such as, a fluid filling operation, an electric charging operation, and the like. In such cases, the light source 122 may operate for the pre-defined time duration which may be long enough to allow the operator to reach a location from which the servicing procedure has to be performed. However, the pre-defined time duration may not be long enough to allow the operator to complete the servicing procedure and return back to the operator cabin 110.

The lighting control system 120 of the present disclosure may allow the light source 122 to operate in an activated state while the servicing procedure is being performed and remain in the activated state until the operator returns back to the operator cabin 110. It should be noted that the lighting control system 120 may allow any user or personnel to perform the servicing procedure associated with the vehicle 100.

The lighting control system 120 further includes one or more sensing elements 126. The sensing element 126 generates an input signal 128 indicative of the fluid filling operation of the vehicle 100 and/or an interaction with the electric charging system 130 of the vehicle 100. In other words, the sensing element 126 generates the input signal 128 that indicates if the fluid filling operation of the vehicle 100 is being performed and/or indicates the interaction of the electric charging system 130 of the vehicle 100. The sensing element 126 may include any device that provides the indication of an ongoing fluid filling operation and/or the interaction of the electric charging system 130 of the vehicle 100.

In some embodiments, the sensing element 126 may be associated with a fuel tank 132 of the vehicle 100. In such embodiments, the input signal 128 is indicative of an increase in a fuel level 156 within the fuel tank 132. In examples wherein the sensing element 126 is associated with the fuel tank 132 of the vehicle 100, the sensing element 126 may be embodied as a fuel level sensor 148 that may indicate the increase in the level of the fuel within the fuel tank 132. Alternatively, the sensing element 126 may include any other sensor or combination of sensors that may indicate the ongoing fuel filling operation.

In some embodiments, the sensing element 126 may be associated with a diesel exhaust fluid (DEF) tank 134 of the vehicle 100. In such embodiments, the input signal 128 is indicative of an increase in a DEF level 158 within the DEF tank 134. The DEF tank 134 may be associated with an aftertreatment system (not shown) associated with the vehicle 100 that may treat exhaust gases exiting the engine of the vehicle 100. In examples wherein the sensing element 126 is associated with the DEF tank 134 of the vehicle 100, the sensing element 126 may be embodied as a DEF level sensor 146 that may indicate the increase in the level of the DEF within the DEF tank 134. Alternatively, the sensing element 126 may include any other sensor or combination of sensors that may indicate the ongoing DEF filling operation.

In some embodiments, the sensing element 126 may be associated with the battery pack 136 to indicate an increase in a state of charge 160 of the battery pack 136. In such embodiments, the sensing element 126 may include a charge sensing element 150 that may include a current sensor, a voltage sensor, or a temperature sensor that may indicate the increase in the state of charge 160 of the battery pack 136. In an example, the sensing element 126 may include an electronic means that may sense voltage changes automatically thereby implying that the battery pack 136 is being charged. It should be noted that, the sensing element 126 may include any other sensor or combination of sensors that may indicate the increase in the state of charge 160 of the battery pack 136.

In some embodiments, the sensing element 126 may be associated with the charging port 138 to indicate an interaction of the charging cable 162 with the charging port 138. In an embodiment, the sensing element 126 may include a switch 152 that may be activated when the charging cable 162 is connected with the charging port 138. Alternatively, the sensing element 126 may include any other sensor or combination of sensors that may indicate the interaction of the charging cable 162 with the charging port 138.

In some embodiments, the sensing element 126 may include a switch 154 associated with the cover 140 to indicate the movement of the cover 140 between the open position and the closed position. Alternatively, the sensing element 126 may include any other sensor or combination of sensors that may indicate the movement of the cover 140 between the open position and the closed position. It should be noted that, in some examples, wherein the vehicle 100 includes the engine, the lighting control system 120 may include each of the fuel level sensor 148 and the DEF level sensor 146. In another example, wherein the vehicle 100 includes an electric drive system, the lighting control system 120 may include the charge sensing element 150, the switch 152, and the switch 154. Alternatively, if the vehicle 100 incorporates a hybrid drive system, the lighting control system 120 may include each of the fuel level sensor 148, the DEF level sensor 146, the charge sensing element 150, the switch 152, and the switch 154.

The lighting control system 120 further includes a controller 142 communicably coupled to the sensing element 126 and the timer 124. The controller 142 may include one or more processors and one or more memories communicably coupled to the one or more processors. It should be noted that the one or more processors may embody a single microprocessor or multiple microprocessors for receiving various input signals. Numerous commercially available microprocessors may be configured to perform the functions of the one or more processors. Each processor may further include a general processor, a central processing unit, an application specific integrated circuit (ASIC), a digital signal processor, a field programmable gate array (FPGA), a digital circuit, an analog circuit, a microcontroller, any other type of processor, or any combination thereof. Each processor may include one or more components that may be operable to execute computer executable instructions or computer code that may be stored and retrieved from the one or more memories.

In some cases, the pre-defined time duration may be stored in the memories associated with the controller 142. The controller 142 receives the input signal 128 from the sensing element 126 prior to an elapse of the pre-defined time duration. In an example, if the pre-defined time duration is about 1 minute, the controller 142 may receive the input signal 128 from the sensing element 126 prior to elapse of 1 minute, for example, 10 seconds prior to the elapse of 1 minute. In other words, if the pre-defined time duration is about 1 minute, the controller 142 may receive the input signal 128 from the sensing element 126 at 50 seconds. It should be noted that the pre-defined time duration and other values of time as provided in this disclosure are exemplary in nature, and may vary as per application requirements.

The controller 142 further transmits a control signal 144 to the timer 124 based on receipt of the input signal 128. Specifically, the control signal 144 resets the timer 124 to the triggered state to activate the light source 122 until a completion of the fluid filling operation of the vehicle 100 and/or the interaction with the electric charging system 130 of the vehicle 100. In some examples, the control signal 144 to the timer 124 may, at minimum, cause the light source 122 to be activated for an additional time duration in addition to the pre-defined time duration. In some examples, the pre-defined time duration and the additional time duration may have the same value. For example, each of the pre-defined time duration and the additional time duration may be 1 minute. In an example, if the pre-defined time duration is 1 minute, the control signal 144 may cause the light source 122 to be activated for the additional time duration of 1 minute in addition to the pre-defined time duration of 1 minute.

The additional time duration may also be saved within the memories of the controller 142. It should be noted that the pre-defined time duration and the additional time duration may be configurable by operators as per their preference. Further, the pre-defined time duration and the additional time duration may be decided such that the operator may comfortably return to the operator cabin 110 after completing the fluid filling operation and/or the electric charging operation.

In some embodiments, the controller 142 transmits a number of control signals 144 to the timer 124 to reset the timer 124 to the triggered state to activate the light source 122 until the completion of the fluid filling operation of the vehicle 100 and/or the interaction with the electric charging system 130 of the vehicle 100. In an example, the controller 142 may continue transmitting the control signals 144 to the timer 124 to reset the timer 124 to the triggered state until the fluid filling operation of the vehicle 100 is being performed and/or based on the interaction of the electric charging system 130 of the vehicle 100.

In an example, if the pre-defined time duration is about 1 minute, the controller 142 may transmit a first control signal (similar to the control signal 144) to the timer 124 to reset the timer 124 to the triggered state. Based on the first control signal, the light source 122 may run for a first additional time duration of 1 minute. However, before an elapse of the first additional time duration, if the controller 142 determines that the fluid filling operation of the vehicle 100 and/or the interaction with the electric charging system 130 of the vehicle 100 is still in progress, the controller 142 may send a second control signal (similar to the control signal 144) to the timer 124 to reset the timer 124 to the triggered state. Based on the second control signal, the light source 122 may run for a second additional time duration of 1 minute. Accordingly, the controller 142 may keep transmitting the control signals 144 based on receipt of the input signal 128 to keep the light source 122 activated until the completion of fluid filling operation of the vehicle 100 and/or the interaction with the electric charging system 130 of the vehicle 100.

It is to be understood that individual features shown or described for one embodiment may be combined with individual features shown or described for another embodiment. The above described implementation does not in any way limit the scope of the present disclosure. Therefore, it is to be understood although some features are shown or described to illustrate the use of the present disclosure in the context of functional segments, such features may be omitted from the scope of the present disclosure without departing from the spirit of the present disclosure as defined in the appended claims.

### INDUSTRIAL APPLICABILITY

The lighting control system 120 may allow the operator to perform fluid filling operation of the vehicle 100 and/or charging of electric components of the vehicle 100 in dark or at night. Furthermore, the controller 142 may transmit multiple control signals 144 to the timer 124 to retain the light source 122 in the activated state until the completion of the fluid filling operation of the vehicle 100 and/or the interaction with the electric charging system 130 of the vehicle 100. Thus, the light source 122 of the lighting control system 120 may illuminate one or more portions of the vehicle 100 to allow the operator to complete tasks associated with the vehicle 100 and may further allow the operator to comfortably return to the vehicle 100.

Moreover, the lighting control system 120 provides an autonomous system which may reduce operator effort of manually switching ON or OFF the light source 122 in order to perform the fluid filling operations and/or charging of the electric components of the vehicle 100.

Further, the lighting control system 120 when compared to conventional lighting systems, may provide clear line of sight in darkness or at night to the operator until the completion of the fluid filling operation of the vehicle 100 and/or the interaction with the electric charging system 130 of the vehicle 100. Furthermore, the lighting control system 120 of the present disclosure may be retrofitted on exiting vehicles. Moreover, the lighting control system 120 as described herein is cost effective, as the sensing element 126 that generates the input signal 128 may already be equipped on the vehicle 100.

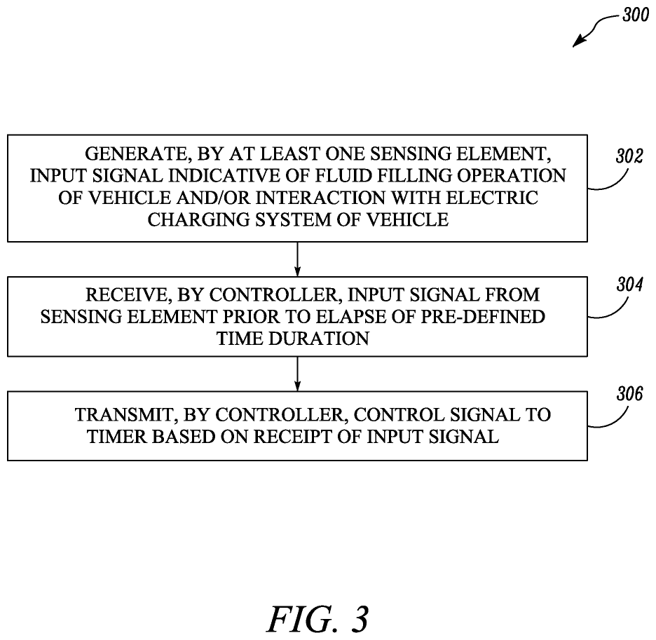

Referring to FIG. 3, a flowchart for a method 300 of controlling one or more light sources 122 associated with the vehicle 100 of FIG. 1 is shown. The light source 122 is operably coupled to the timer 124. In the triggered state of the timer 124, the timer 124 activates the light source 122 for the pre-defined time duration. With reference to FIGS. 1, 2, and 3, at step 302, the one or more sensing elements 126 generate the input signal 128 indicative of the fluid filling operation of the vehicle 100 and/or the interaction with the electric charging system 130 of the vehicle 100.

At step 304, the controller 142 receives the input signal 128 from the sensing element 126 prior to the elapse of the pre-defined time duration. In an example, the sensing element 126 is associated with the fuel tank 132 of the vehicle 100. In such an example, the controller 142 receives the input signal 128 indicative of the increase in the fuel level 156 within the fuel tank 132.

In another example, the sensing element 126 is associated with the DEF tank 134 of the vehicle 100. In such an example, the controller 142 receives the input signal 128 indicative of the increase in the DEF level 158 within the DEF tank 134.

In yet another example, the electric charging system 130 includes the battery pack 136. Further, the sensing element 126 is associated with the battery pack 136 to indicate the increase in the state of charge 160 of the battery pack 136. In such an example, the controller 142 receives the input signal 128 indicative of the increase in the state of charge 160 of the battery pack 136.

In an example, the electric charging system 130 further includes the charging port 138 in communication with the battery pack 136. The sensing element 126 is associated with the charging port 138 to indicate the interaction of the charging cable 162 with the charging port 138. In such an example, the controller 142 receives the input signal 128 indicative of the interaction of the charging cable 162 with the charging port 138.

In another example, the electric charging system 130 further includes the cover 140 to enclose the charging port 138. Furthermore, the sensing element 126 includes the switch 152 associated with the cover 140 to indicate the movement of the cover 140 between the open position and the closed position. In such an example, the controller 142 receives the input signal 128 indicative of the movement of the cover 140 between the open position and the closed position.

At step 306, the controller 142 transmits the control signal 144 to the timer 124 based on receipt of the input signal 128. The control signal 144 resets the timer 124 to the triggered state to activate the light source 122 until the completion of the fluid filling operation of the vehicle 100 and/or the interaction with the electric charging system 130 of the vehicle 100. In some examples, the controller 142 transmits the number of control signals 144 to the timer 124 to reset the timer 124 to the triggered state to activate the light source 122 until the completion of the fluid filling operation of the vehicle 100 and/or the interaction with the electric charging system 130 of the vehicle 100.

While aspects of the present disclosure have been particularly shown and described with reference to the embodiments above, it will be understood by those skilled in the art that various additional embodiments may be contemplated by the modification of the disclosed work machine, systems and methods without departing from the spirit and scope of the disclosure. Such embodiments should be understood to fall within the scope of the present disclosure as determined based upon the claims and any equivalents thereof.

1. A lighting control system for a vehicle, the lighting control system comprising:
at least one light source mounted on the vehicle to illuminate one or more portions of the vehicle;
a timer operatively coupled to the light source, wherein, in a triggered state of the timer, the timer is configured to activate the light source for a pre-defined time duration;
at least one sensing element configured to generate an input signal indicative of a fluid filling operation of the vehicle and/or an interaction with an electric charging system of the vehicle; and
a controller communicably coupled to the sensing element and the timer, wherein the controller is configured to:
receive the input signal from the sensing element prior to an elapse of the pre-defined time duration; and
transmit a control signal to the timer based on receipt of the input signal, wherein the control signal is configured to reset the timer to the triggered state to activate the light source until a completion of the fluid filling operation of the vehicle and/or the interaction with the electric charging system of the vehicle.

2. The lighting control system of claim 1, wherein the controller is further configured to transmit a plurality of control signals to the timer to reset the timer to the triggered state to activate the light source until the completion of the fluid filling operation of the vehicle and/or the interaction with the electric charging system of the vehicle.

3. The lighting control system of claim 1, wherein the sensing element is associated with a fuel tank of the vehicle, and wherein the input signal is indicative of an increase in a fuel level within the fuel tank.

4. The lighting control system of claim 1, wherein the sensing element is associated with a diesel exhaust fluid (DEF) tank of the vehicle, and wherein the input signal is indicative of an increase in a DEF level within the DEF tank.

5. The lighting control system of claim 1, wherein the electric charging system includes a battery pack, and wherein the sensing element is associated with the battery pack to indicate an increase in a state of charge of the battery pack.

6. The lighting control system of claim 5, wherein the electric charging system further includes a charging port in communication with the battery pack, and wherein the sensing element is associated with the charging port to indicate an interaction of a charging cable with the charging port.

7. The lighting control system of claim 6, wherein the electric charging system further includes a cover configured to enclose the charging port, and wherein the sensing element includes a switch associated with the cover to indicate a movement of the cover between an open position and a closed position.

8. The lighting control system of claim 1, wherein the vehicle includes a work machine.

9. A method of controlling at least one light source associated with a vehicle, wherein the light source is operably coupled to a timer, and wherein, in a triggered state of the timer, the timer is configured to activate the light source for a pre-defined time duration, the method comprising:
generating, by at least one sensing element, an input signal indicative of a fluid filling operation of the vehicle and/or an interaction with an electric charging system of the vehicle;
receiving, by a controller, the input signal from the sensing element prior to an elapse of the pre-defined time duration; and
transmitting, by the controller, a control signal to the timer based on receipt of the input signal, wherein the control signal is configured to reset the timer to the triggered state to activate the light source until a completion of the fluid filling operation of the vehicle and/or the interaction with the electric charging system of the vehicle.

10. The method of claim 9, further comprising transmitting, by the controller, a plurality of control signals to the timer to reset the timer to the triggered state to activate the light source until the completion of the fluid filling operation of the vehicle and/or the interaction with the electric charging system of the vehicle.

11. The method of claim 9, wherein the sensing element is associated with a fuel tank of the vehicle, and wherein the method includes receiving, by the controller, the input signal indicative of an increase in a fuel level within the fuel tank.

12. The method of claim 9, wherein the sensing element is associated with a diesel exhaust fluid (DEF) tank of the vehicle, and wherein the method includes receiving, by the controller, the input signal indicative of an increase in a DEF level within the DEF tank.

13. The method of claim 9, wherein the electric charging system includes a battery pack, wherein the sensing element is associated with the battery pack to indicate an increase in a state of charge of the battery pack, and wherein the method includes receiving, by the controller, the input signal indicative of the increase in the state of charge of the battery pack.

14. The method of claim 13, wherein the electric charging system further includes a charging port in communication with the battery pack, wherein the sensing element is associated with the charging port to indicate an interaction of a charging cable with the charging port, and wherein the method includes receiving, by the controller, the input signal indicative of the interaction of the charging cable with the charging port.

15. The method of claim 14, wherein the electric charging system further includes a cover configured to enclose the charging port, and wherein the sensing element includes a switch associated with the cover to indicate a movement of the cover between an open position and a closed position.
